(19) United States
(12) Patent Application Publication
(10) Pub. No.: US 2017/0289224 A1
(43) Pub. Date: Oct. 5, 2017

(54) Multimedia card service system and method

(71) Applicant: Jongsub Moon, Glenview, IL (US)

(72) Inventor: Jongsub Moon, Glenview, IL (US)

(21) Appl. No.: 15/088,024

(22) Filed: Mar. 31, 2016

(51) Int. Cl. H04L 29/06; H04M 1/02; H04B 1/3816; H04W 4/00; H04B 5/00

(52) U.S. Cl. CPC H04L 65/601; H04W 4/008; H04B 5/0031; H04B 5/0062; H04B 1/3816; H04M 1/0202

(57) ABSTRACT

This invention disclosure relates to a service system and service method where a handwritten message and video information are sent together on a paper card to a recipient. Then, the recipient reads the contents of the card and retrieves the video file from the card.

To do this, following sequential steps are required; the step in which a video file in a mobile device is sent to a video server and saved into the server; the step in which an index information for the saved video file is generated; the step in which the index generated in the server is sent to the mobile device; the step in which the received index information is stored in NFC tag within a paper card; the step in which the paper card containing the NFC tag is delivered to a target person; the step in which the index information of the card's NFC is extracted by the mobile device of the receiver; the step in which the extracted index is sent to the video server, then, the server searches the matching file with the index and the found file is sent back to the mobile device; and the step in which the downloaded file is played on the screen of the mobile device.

### TECHNICAL FIELD

This invention disclosure a system and service which delivers a video information with the written information on the paper card. In detail, a video picture taken with a camera of the smart-phone (mobile device) is transferred to and stored on a video server and, then, the generated index of the video file from the server is sent back to the same mobile device and saved to the NFC (RFID) tag inside in a paper card through NFC facility in the mobile device-phone. This paper card is sent to a targeted receiver. Then, the receiver open the paper card and, then read the written content in the card. At the same time, if the reader contacts the paper card with the mobile device, the app in the smart phone retrieves the index stored in the tag. The app requests the video file from the video server with the index information. The video server retrieves the video from the server and then, send the video picture to the corresponding mobile device. Finally, the card receiver watch the contents of the video.

From this point, the terminology of “mobile device” is used for all kind of device which can communicate with other device via internet and equip with camera and NFC functions.

Therefore, the field of this invention contains the NFC control, Application programming in a mobile (Mobile programming), Video service programming in a server.

### BACKGROUND OF THE INVENTION

This invention describes the system which consists of a video server, mobile device and RFID tag control. The video server should have facilities which saves the video file and retrieves the stored file with key in a database engine. The video server should be connected with the mobile device through internet. The mobile device should install some software (app), equip NFC facility and also Communication facility like 3G, 4G and/or WIFI. So, the software in this invent is based on the following techniques.

1. Application software programming in Mobile (Java Programming)

2. The programming technique for Near Field Communication (NFC), i.e., ISO/IEC 14443-A, 14443-B

3. Software programming in a server (Video server programming, web programming)

4. Database application programming

The techniques for each component which consist this invent are well known, but there are two similar invents as this invent. The first one is titled as “CONTENTS PROVIDING SYSTEM USING RFID TAG” (Korean Patent registration number 1011100430000), and the second is titled as “METHOD AND SYSTEM FOR CONVEYING MULTI-MEDIA MESSAGE WITH TWO DIMENSIONAL BAR CODE” (Korean Patent Rejected, no 2005-0099922). However, these invents are irrelevant to this invent. That is, no other publically known patent similar like this is not known yet.

### SUMMARY OF INVENTION

### Technical Problem

When a person sends a paper card to another person, the person writes a paragraph such as “Congratulation” or “I love you” on the paper card. At those time, the person can't send a digital photograph or video inside the paper card because they are intangible data. If the person wants to send a picture or video file, he uses an indirect methods such as sending the video file through e-mail or store the file on the video server like “YOUTUBE” server. Then, the receiver retrieve the e-mail or link from e-mail server and then, watches the picture or video with the corresponding server. In this case, the media for both kind of data are separated. One is a paper card and the other is a digital media sent by e-mail. They can't be synchronized. So, we need a media which contains both kind of data at the same time.

### Solution to Problem

For this, the multimedia card service system, in this invent, consists of a paper card with NFC(RFID) tag; a mobile device which can be connected with internet, equipped with Near Field Communication facility and camera facility; a video server. The video server stores a video file into its database, then, generates the index, and then, send the index information to the mobile device which sent the video file. Also, the video server retrieves the corresponding video file with the link which was sent from the mobile device and send the file to the mobile device.

For this, the mobile device in this structure contains a number of blocks as follows; a block which performs both taking a picture (including video) with the camera installed in the mobile device and storing the taken picture into the mobile device (called a video generating block); a block which performs selecting a picture among the taken pictures (called a selecting video block); a block which performs send a selected video file to a video server and receives the index (or link) of the stored video file on the server (called a storing video block); a block which stores the link into the RFID tag from the storing block (called NFC storing block); a block which performs sending a extracted link information from NFC(RFID) tag to a video server and downloading the electronic video file from the video server (called acquiring index block); and a block which display the video files achieving from the achieving block on the display screen.

To do this, the video server contains the block which performs storing the video file (and/or picture files) into its database, and then generating the index information for the storing file and then, sending the index information to the sender (mobile device) who sent the video file (called a video storing block) and the block which performs searching a video files with the key (link information) which sent from a mobile device and, then the found file to the requester who request the video file corresponding the key (called a video searching block).

To do this, this invent uses 3G, 4G or wireless internet, but not limited to them and also uses Near field communication technique which uses ISO 14443-A, or 14443-B standards, but not limited to them. That means, it requires the minimum functions which can both read the information contained in NFC(RFID) tag and write information into the tag.

Also, this invent consists of following sequential steps; the step in which the video file or picture file taken in a mobile device is sent to a video server and saved into the video server; the step in which a link information for the being saved video file is generated; the step in which the link generated in the video server is sent to the mobile device and the mobile device is receiving the link; the step in which the received link information is stored in NFC tag within a paper card; the step in which the paper card containing the NFC tag is delivered to a target person by postman; the step in which the link information of the received paper card's NFC are extracted by the NFC module in mobile device of the receiver; the step in which the link information extracted is sent to the video server, then, the video server searches the video file with the link and the found file is sent back to the mobile device which sent the link information; and the step in which the downloaded file is played and is displayed on the screen of the mobile device.

### Advantageous Effects of Invention

When using the service system according to this invention, the recipient can watch the video file whose index information is contained in the sender's paper card as the recipient contacts his mobile device to the paper card without any specific application program (app). If a sender install the application program which provides this functions, he can make the media very easily. Therefore, peoples can use more services with the traditional paper card only with NFC tag.

### BRIEF DESCRIPTION OF DRAWINGS

FIG. 1 is a block diagram that illustrates composition of the service system of this invention.

FIG. 2 is a block diagram that illustrates detailed composition of the service system of this invention.

FIG. 3 is a block diagram that illustrates functions of the application program operated on the mobile device of this invention.

FIG. 4 is a block diagram that illustrates functions of the server program operated on the video server of this invention.

FIG. 5 illustrates each step of the process in which video index information is saved on the NFC tag.

FIG. 6 illustrates each step of the process in which the mobile device obtains the video index from the RFID tag, acquires the video from the video server using this video index, and displays the corresponding video.

### DESCRIPTION OF EMBODIMENTS

Aforementioned and additional aspects of this invention will become clearer by the preferred embodiments explained using the attached drawings. This invention will be explained through such embodiments below to help the persons skilled in the relevant field of technology to understand and reproduce the invention easily.

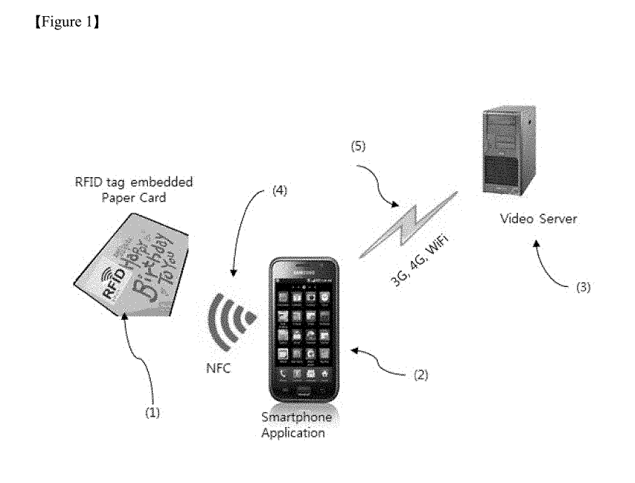

FIG. 1 briefly illustrates overall composition of the service system based on this invention. The service system based on this invention is a medium that consists of a paper card (1) into which an NFC (RFID) tag is inserted according to ISO/IEC 14443-A or ISO/IEC 14443-B standard, a mobile device (2) installed with an application program to provide the service according to this invention, and a video server computer (3) connected with internet (5) to provide the service. The mobile device (2) must be attached with a camera, which can provide NFC facility (4). The paper card is a card on which messages can be handwritten to be delivered via postal mail or hand, inserted with an RFID tag inside. The tag inserted in the paper may be either RFID or NFC which can be read/write from mobile device. Hereafter, the terminology of NFC is used for both kind of tags. The mobile device can use the NFC function to save or to retrieve information to/from the NFC tag. The video server saves the received video on its database when a mobile device request to do it. Then, the server generates video index (hereafter, index) information matching the video content and transmit it to the mobile device. The video server search the video contents on its database when requested with an index from external mobile device and send it to the external device.

The mobile device uses 3G (WCDMA), 4G (LTE), wireless internet (WIFI) or next-generation wireless communication to appear in the future for communicating with the video server. The terminologies of video data, video file, video picture or video information used in this invention are all the same meaning, which is video clips or photographs that contain visual and/or auditory information.

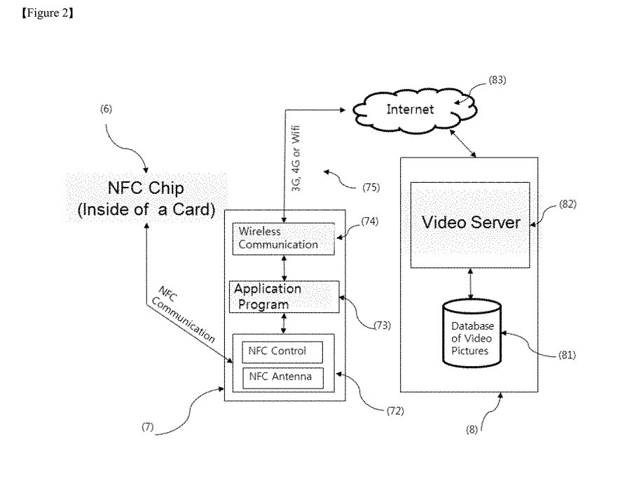

FIG. 2 illustrates a block diagram according to detailed composition of the service system based on an embodiment of this invention.

In other words, the paper card (6) internalized with an NFC tag is a card that contains an NFC tag that satisfies ISO 14443-A or 14443-B standard or other international standard specified for the tag. The paper card includes a sign explaining that the card includes NFC tag which can be used to read the video index in the tag and view the saved video. The mobile device (7) refers to a device like smart phone that uses 3G (WCDMA), 4G (LTE) or next-generation wireless communication to appear in the future, includes wireless communication part (74) that connects to the video server using internet protocol, runs the application program (73) necessary, and includes NFC (72) part.

The NFC (72) part consists of an NFC antenna that emits or receives wireless signals and an NFC control part that transmits data through the antenna or detects data of signals received from the antenna. Since frequencies of wireless signals used in the NFC part include 13.56 MHZ, 543 MHZ, 900 MHZ, 2.3 GHZ, and 2.4 GHZ depending on the region, this invention does not set limitation on wireless frequency.

An application program (73) is installed on the mobile device to provide the service according to this invention.

The video server (8) is a computer used alone or along with other services to operate the video database (81). A video server program (82) is installed on the server computer to save video information on this database or search videos saved on the database. The video server program (hereafter, video server) sends and receives necessary information to/from the application program (73) installed on the mobile device via the internet (83).

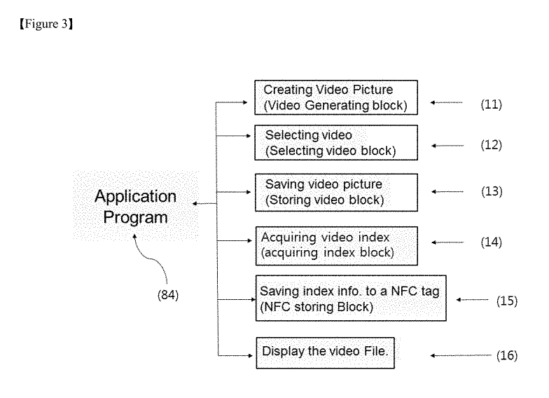

FIG. 3 illustrates basic function blocks of the application program (84) installed on the mobile device including Video generation block (11), Selecting video block (12), Storing video block (13), Acquiring index block (14), NFC storing block (15) and video display block (16). Other functional blocks can be added if necessary for operation.

The application program (app, 84) is a mobile app that embodies functions of the service of this invention. It can be installed by downloading the app from app stores like Google Play once the service provider uploads the app. The app consists of 6 blocks at least.

The video generating block (11) uses the camera installed on the mobile device to make video picture and save the video on the mobile device.

The selecting video block (12) displays the videos and the user selects a video to be stored on the video server among the saved videos, and if necessary, deletes unwanted videos.

The storing video block (13) sends the selected video on the mobile device to the video server, requests the server to save the video and receives video index information about the saved video file from the video server.

The NFC storing block (15) emits video index acquired from the storing video block (13) through NFC facility of the mobile device in order to save it on the NFC tag. Video index information emitted wirelessly from the mobile device is saved on the NFC tag of the paper card.

The acquiring index block (14) sends video index information obtained from the NFC tag to the video server and downloads the video file searched using video index information from the video server. This block can be omitted because we can download all video file with a web browser from a video server if the server provides direct access with link such as “Youtube”.

The video display block (16) displays video picture downloaded from the video server on the screen of the mobile device

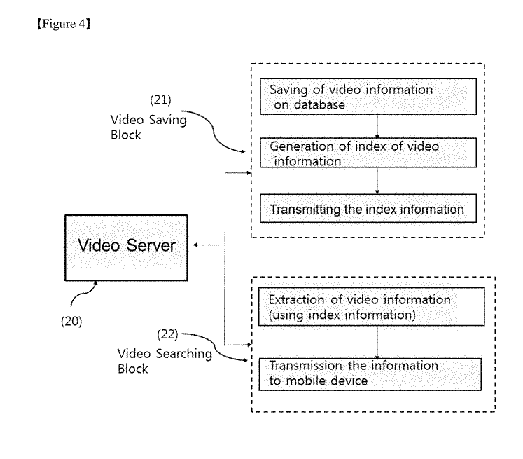

FIG. 4 shows functional blocks of the video server that correspond to functional blocks of the application program on the mobile device. It includes the video storing block (21) and the video searching block (22). Other function blocks can be added if necessary for operation.

When a video file is saved by the video saving block (21), video index information of the corresponding video file in database is generated. The video searching block (22) uses video index information received from the mobile device to extract the corresponding video from the video database. Video index information generated by the video saving block (21) and the video file searched by the video searching block (22) are respectively transmitted to the requesting mobile device via the internet.

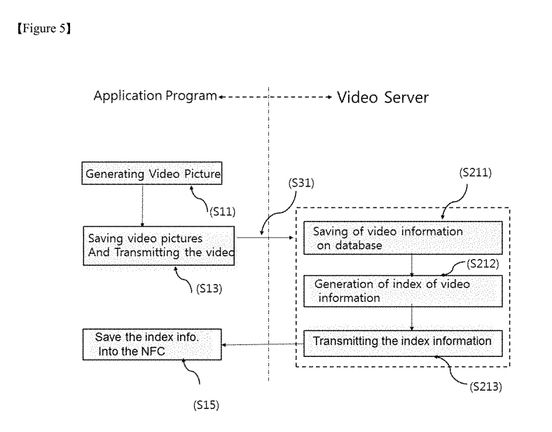

FIG. 5 is a detailed illustration of the operating sequence (protocol) carried out by the storing video block (13 of FIG. 3) of the mobile device and the video saving block (21 of FIG. 4) of the video server in order to save the video file. Steps (S211), (S212) and (S213) in FIG. 5 are detailed procedures performed by the video saving block (21) in FIG. 4.

Video file is made (S11) in the video generation block (11 of FIG. 3) of the mobile device, and the video file is transmitted (S31) to the video server through the video saving block (13 of the FIG. 3). The video server saves (S211) the received video on the database, generates (S212) video index information of the saved video, and transmits (S213) video index information. The NFC storing block (15 of FIG. 3) of the mobile device saves (S15) video index information on the NFC tag using the NFC facility of the mobile device.

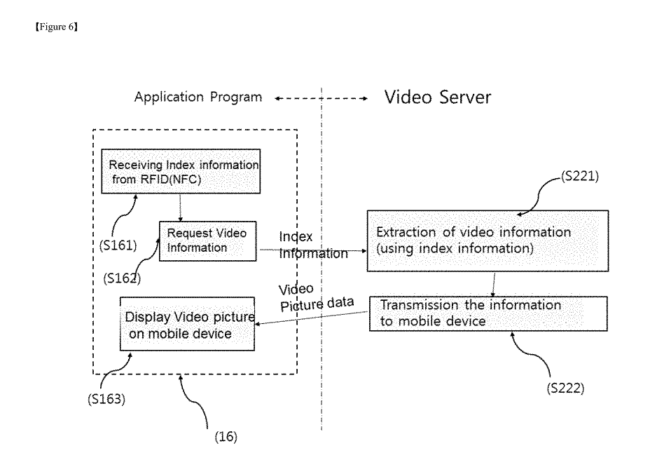

FIG. 6 is a detailed illustration of the operating sequence (protocol) carried out by the video display block (16 of FIGS. 3 and 6) of the mobile device and the video searching block (22 of FIG. 3) of the video server in order to search video using video index information. This shows the process in which video index information saved on the NFC tag of the paper card is used to download the corresponding video file from the video server and display it on the mobile device.

Steps (S161), (S162) and (S163) in Drawing 6 are carried out by the video display block (16) in FIG. 3. Steps (S221) and (S222) in the figure are carried out by the video searching block (22) in FIG. 4. When the video display block (16) is selected on the application program of the mobile device or is performed by a web browser in the mobile device, video index information is extracted (S161) from the NFC tag using NFC facility of the mobile device. The index information is transmitted (S162) to the video server, and the video server search a video file with the video index (S221) on the database. The video server transmits (S222) the searched video file to the requesting mobile device, and the downloaded video is displayed (S163) on the mobile device.

### INDUSTRIAL APPLICABILITY

This invent can be used in paper card market. Until now, we write contents on the paper by hand only and the paper delivered only a written information. However, with this invent, the paper card can also deliver the electronic information. With this invent, a user can watch the move at any time and at any place with the paper card.

1. A multimedia card service system which consists of a structure and two procedures as followings;
Structure:
A paper card with an NFC tag that can record a digital information as well as handwritten message on the paper;
A mobile device with a facility of near field communication (NFC), a facility of wireless communication and video file stored on the mobile device;
A video server that communicates with the mobile device, saves videos received from the mobile device, sends video index as position information of video, searches videos saved using video index received from the mobile device, and transmits the video to the mobile device is included.
Saving procedure;
A step in which a user takes moving picture;
A step in which the mobile device sends the moving picture to a video server;
A step in which the video server saves video to the database;
A step in which the video server send the video index of the saved video to the mobile device;
A step in which the mobile device transmits the index of the index to the NFC tag of the paper card, and then the index information is stored on the NFC tag;
Retrieving procedure:
A step in which recipient who the paper card which include a NFC tag contacts his mobile device to the NFC tag;
A step in which the mobile device send the index information from NFC tag to the video server;
A step in which the video server searches a video file which corresponds the index;
A step in which the video server send the video file searched to the mobile device;
A step in which the mobile device plays the received video file;

2. In the claim 1, an application program executed in a mobile device, which consists of following functional blocks:
The video generating block which uses the camera installed on the mobile device to make video picture and save the video on the mobile device;
The selecting video block which displays the videos and the user selects a video to be stored on the video server among the saved videos, and if necessary, deletes unwanted videos;
The storing video block which sends the selected video on the mobile device to the video server, requests the server to save the video and receives video index information about the saved video file from the video server;
The NFC storing block which emits video index acquired from the storing video block through NFC facility of the mobile device in order to save it on the NFC tag. Video index information emitted wirelessly from the mobile device is saved on the NFC tag of paper card;
The acquiring index block which sends video index information obtained from the NFC tag to the video server and downloads the video file searched using video index information from the video server;
The video display block which displays video picture downloaded from the video server on the screen of the mobile device

3. In the claim 1, a video server which serves the two functions as follows:
A video saving block which consists of following steps:
A step in which a video file is saved in database;
A step in which a video index information of the corresponding video file is generated.
A step in which the video index is sent to the mobile device;
A video searching block which consists of following steps:
A step in which a video file is searched with the index received from the mobile device;
A step in which the found video file is sent to the mobile device.

4. In the claim 1, the mobile device which uses 3G, 4G, WIFI or next generation wireless communication system as communicating device.

5. In the claim 1, a NFC tag which contains the index of the video file stored on a video server instead of video file.
